(19) United States
(12) Patent Application Publication
(10) Pub. No.: US 2022/0130096 A1
(43) Pub. Date: Apr. 28, 2022

(54) REDUCING LATENCY OF AN APPLICATION IN A SERVER-SIDE HOSTED ENVIRONMENT

(71) Applicant: Meta Platforms, Inc., Menlo Park, CA (US)

(72) Inventors: Qunshu Zhang, Sammamish, WA (US); Yangpeng Ou, Redmond, WA (US)

(21) Appl. No.: 17/139,702

(22) Filed: Dec. 31, 2020

Related U.S. Application Data
(60) Provisional application No. 63/105,320, filed on Oct. 25, 2020.

(51) Int. Cl. G06T 15/00; G06T 1/20; G06T 19/00; G06F 9/455; G06F 21/53

(52) U.S. Cl. CPC G06T 15/005; G06T 1/20; G06F 21/53; G06F 9/45533; G06T 19/006

(57) ABSTRACT

The disclosed computer-implemented method for reducing latency of an application in a server-side hosted environment may include (i) receiving, from an application executing in a server-side hosted environment, graphics data to be rendered for display on a remote device through which a user interacts with the application, (ii) providing access, to the application, to a graphics processing unit (“GPU”) in communication with the server-side hosted environment via an operating system (“OS”) virtualization layer, (iii) rendering the graphics data with the GPU, (iv) storing the rendered graphics in shared memory of the GPU, (v) accessing the rendered graphics from shared memory and encoding the rendered graphics with the GPU in a manner that reduces latency in displaying the encoded graphics on the remote device, (vi) providing the encoded graphics to the remote device over a network connection with the remote device. Various other methods, systems, and computer-readable media are also disclosed.

### CROSS REFERENCE TO RELATED APPLICATION

This application claims the benefit of U.S. Provisional Application No. 63/105,320, filed Oct. 25, 2020, the disclosure which is incorporated, in its entirety, by this reference.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is an illustration of an exemplary system for optimizing an application in a server-side hosted environment.

FIG. 2 is a more detailed illustration of various aspects of the system for optimizing an application in a server-side hosted environment.

FIG. 3 is a flow diagram of an exemplary method for optimizing an application in a server-side hosted environment.

FIG. 4 is an illustration of an exemplary graphics pipeline that may be used in connection with embodiments of this disclosure.

FIG. 5 is a flow diagram of an exemplary method for measuring latency of an application in a server-side hosted environment.

FIG. 6 is an illustration of exemplary augmented-reality glasses that may be used in connection with embodiments of this disclosure.

FIG. 7 is an illustration of an exemplary virtual-reality headset that may be used in connection with embodiments of this disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

An increasing amount of software is being hosted in the cloud and delivered to a user remotely. Hosting software with the cloud typically involves an application being executed on a remote server for interaction by an end-user, on the user's device, remotely over a network such as the Internet. The types of cloud-hosted applications may include those that have traditionally been executed on a user's local device such as a mobile device, tablet, or personal computer (“PC”) (“on-premise applications”) and may include applications for word processing, finance, business-related applications, games, and the like. Because the execution environment, architecture, and hardware on the servers that run a cloud-hosted system typically vary significantly from those on an end-user device, applications traditionally may be specifically written as cloud-hosted applications and designed specifically to run on a cloud-hosted server to enable adequate performance.

Likewise, certain pre-existing, on-premise applications, intended originally to execute on a local device, may require heavy modification to run in a cloud-hosted infrastructure environment to accommodate various hardware and software differences inherent in the cloud-hosted infrastructure. For example, a local device environment may include a local display without layers of virtualization rather than a headless system with one or more virtualized layers more typical in a server environment such as those supporting cloud-hosted infrastructure. Due to hardware and software differences between a local environment and a cloud-hosted infrastructure environment such as these, the applications may require significant modifications to enable adequate performance and a suitable user experience.

The present disclosure is generally directed to systems and methods for reducing latency of an application in a server-side hosted environment executing in a cloud-hosting infrastructure to provide a cloud-hosted application. As will be explained in greater detail below, embodiments of the present disclosure may receive, from an application executing in a server-side hosted environment, graphics data to be rendered for display on a remote device, provide access, to the application, to a graphics processing unit (“GPU”) in communication with the server-side hosted environment via an operating system (“OS”) virtualization layer, render and encode the graphics data with the GPU, and provide the encoded graphics to the remote device.

By performing certain optimizations, such as making the GPU available to the application and rendering and encoding the graphics data with the GPU, embodiments of the present disclosure may reduce latency in displaying the encoded graphics on the remote device and reduce the likelihood of performance degradation that may interfere with the user experience of using the cloud-hosted application with a remote device. In some examples, the application is non-native to the server-side hosted environment. Specifically, the application may be designed to run on an end-user device, such as a mobile device or PC rather than in a virtualized environment of cloud-hosted infrastructure for delivery over a network. By optimizing the execution of applications in the server-side hosted environment, including applications non-native to that environment, embodiments of the present disclosure may improve the functioning of computers supporting the server-side hosted environment, cloud-hosted infrastructure, remote devices through which user's interact with the applications, and may allow end-users to use more of a variety of applications with cloud-hosted infrastructure. In this manner, embodiments of the present disclosure may improve the cloud-hosted application technology systems and also spare application or cloud-hosted infrastructure developers from having to invest resources in adapting or creating applications specific to cloud-hosted infrastructure environments.

In general, the present disclosure will provide detailed descriptions of embodiments related to (1) receiving, from an application executing in a server-side hosted environment, graphics data to be rendered for display on a remote device through which a user interacts with the application, (2) providing access, to the application, to a GPU in communication with the server-side hosted environment via an operating system (“OS”) virtualization layer, (3) rendering the graphics data with the GPU, (4) storing the rendered graphics in shared memory of the GPU, (5) accessing the rendered graphics from shared memory and encoding the rendered graphics with the GPU in a manner that reduces latency in displaying the encoded graphics on the remote device, and (6) providing the encoded graphics to the remote device over a network connection with the remote device.

Features from any of the embodiments described herein may be used in combination with one another in accordance with the general principles described herein. These and other embodiments, features, and advantages will be more fully understood upon reading the following detailed description in conjunction with the accompanying drawings and claims.

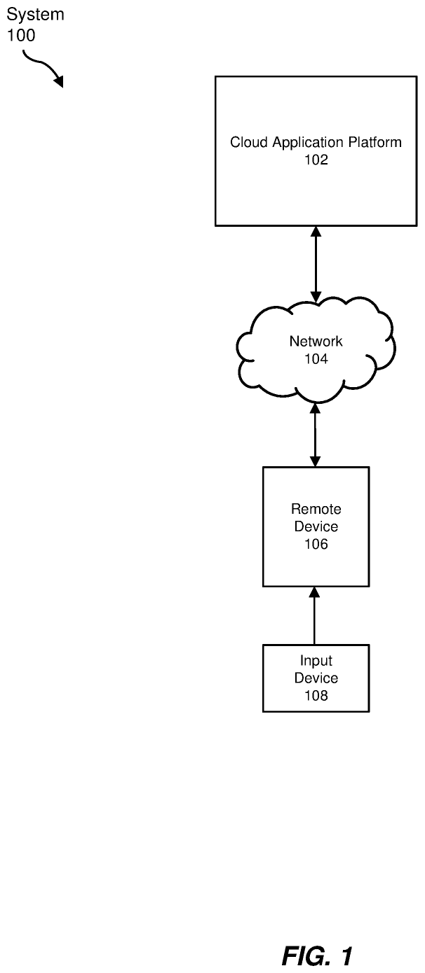

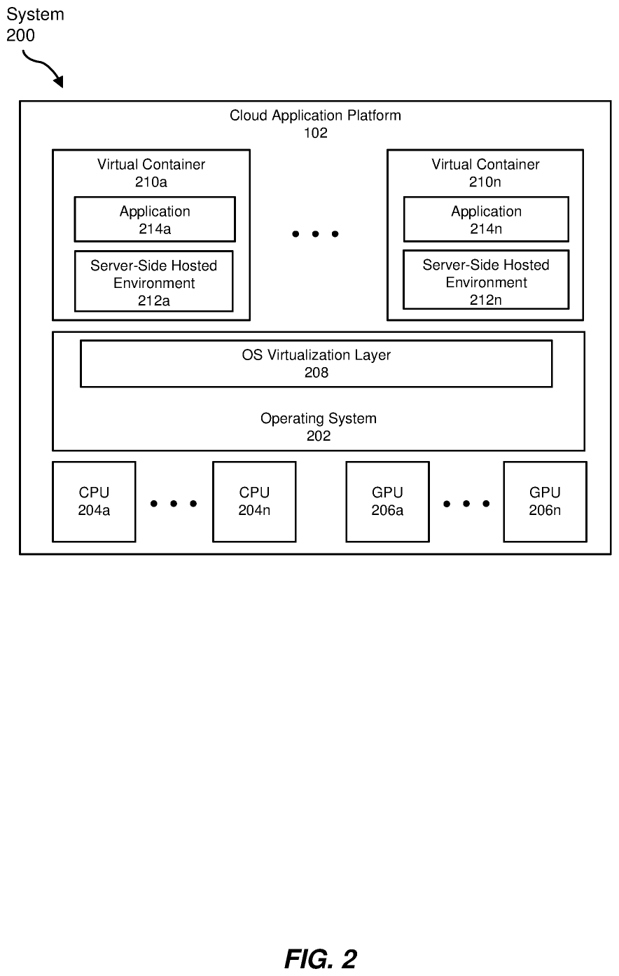

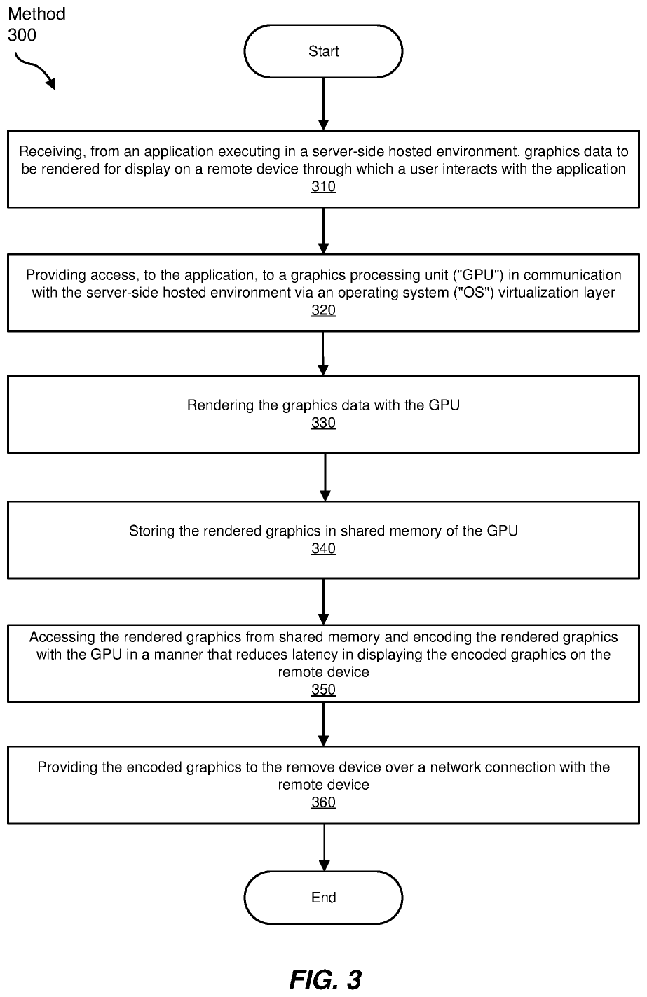

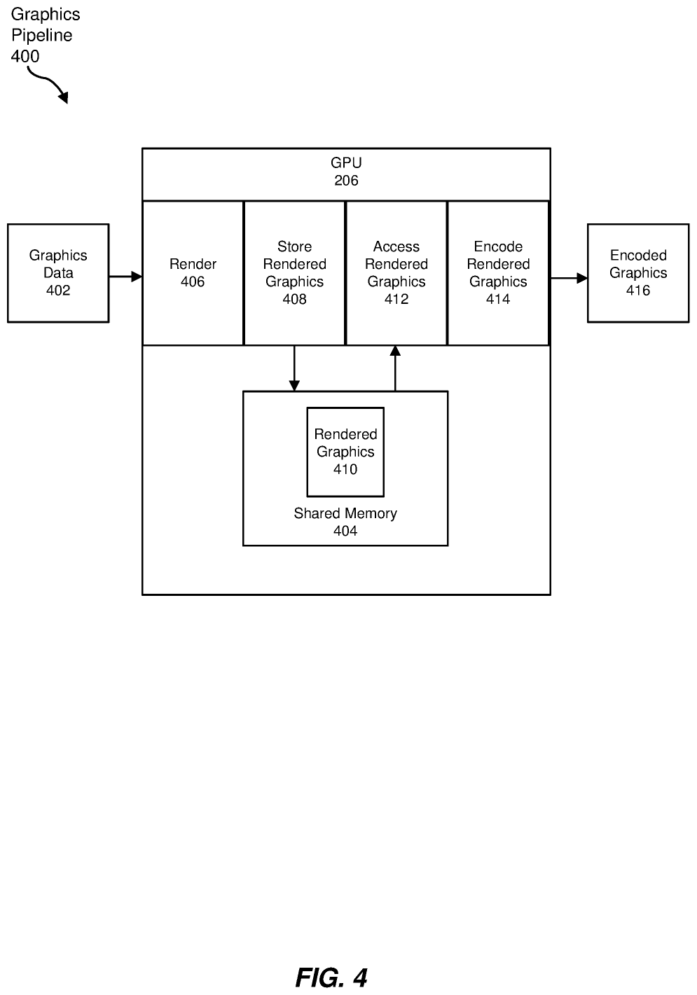

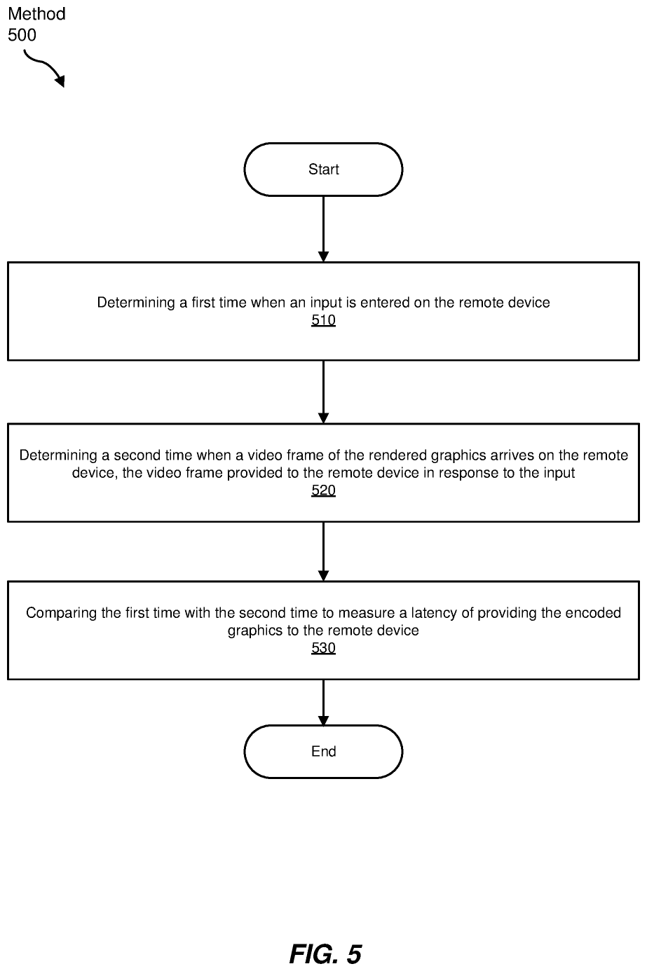

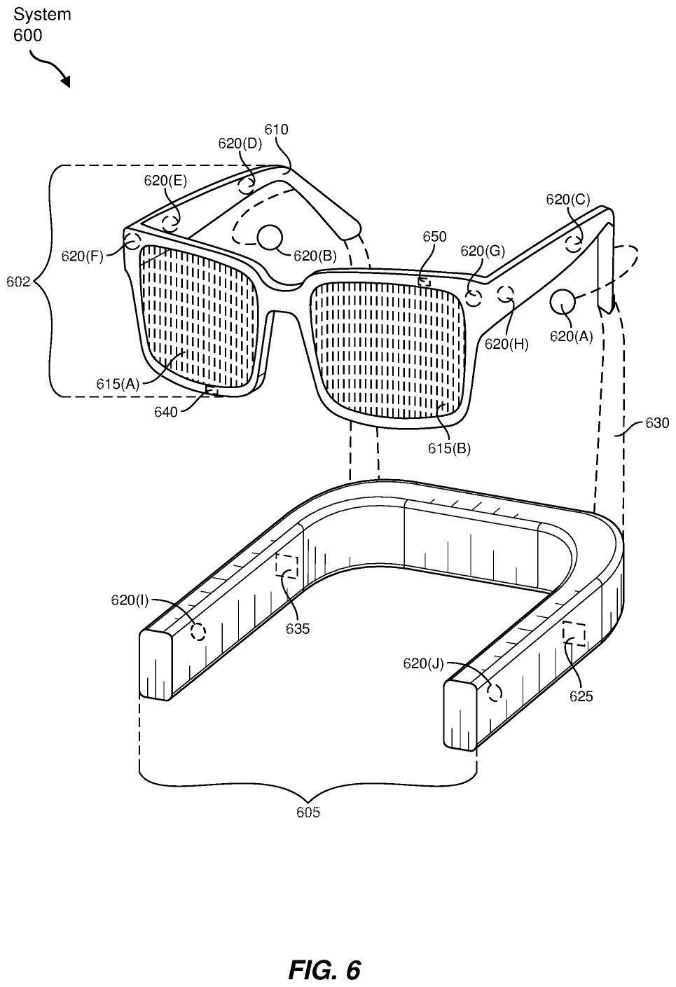

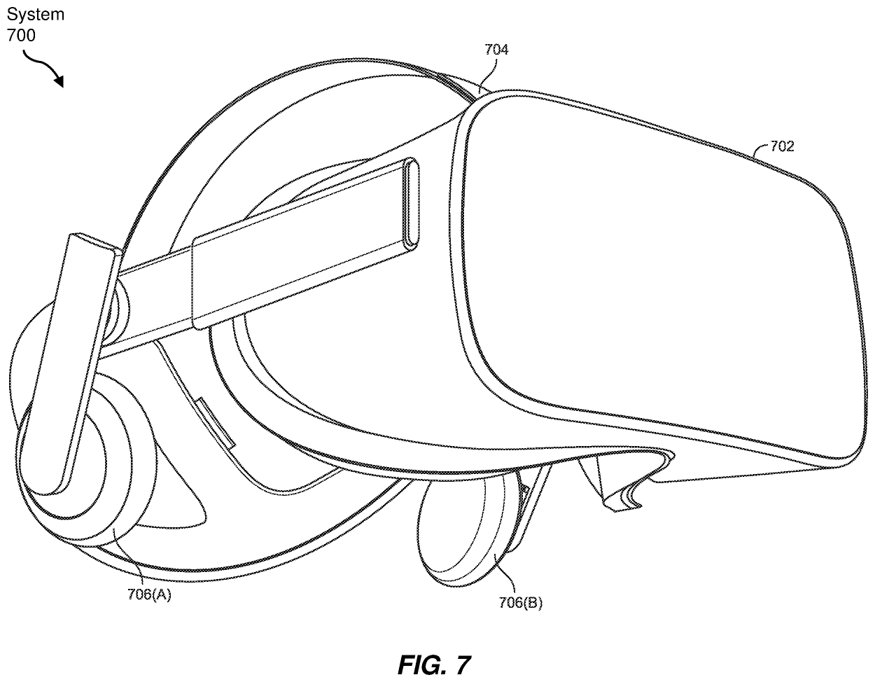

The following will provide, with reference to FIGS. 1-2, exemplary systems for optimizing an application in a server-side hosted environment, FIG. 3 which depicts an exemplary method for optimizing an application in a server-side hosted environment, and FIG. 4, which depicts an exemplary graphics pipeline in accordance with the present disclosure. The following will also provide FIG. 5 which depicts a method for measuring latency of an application in a server-side hosted environment. Furthermore, the following will also provide, with reference to FIGS. 6-7, detailed descriptions of artificial-reality systems including augmented-reality glasses and a virtual-reality headset which, in some examples, may be used as remote devices in accordance with the present subject matter.

As mentioned above, applications may be typically designed and created specifically for execution in server-side, cloud-hosted infrastructure. In addition to these native cloud-hosted applications, applications designed for on-premise execution in a user-device may be modified to run in cloud-hosted infrastructure. The exemplary system depicted in FIG. 1, in certain examples, may allow for an application that is non-native to the server-side hosted environment to execute as a cloud-hosted application with little to no modification to the application itself.

As illustrated in FIG. 1, the system 100 may include a cloud application platform 102 communicating with a remote device 106 over a network 104. The cloud application platform 102 may include servers and other software and hardware to host, run, and/or execute an application to provide content, such as, but not limited to, graphics and audio content to the remote device 106. In certain examples, the cloud application platform 102 is at least a portion of and/or is embodied as cloud-hosted infrastructure to provide content for delivery to remote devices 106 over the Internet. Furthermore, although a single cloud application platform 102 is depicted, in certain examples, cloud-hosted infrastructure may include multiple instances of the cloud application platform 102.

Regarding the network 104, any suitable network 104 may be used. In certain examples, the network 104 is the Internet, a LAN, a WAN, or the like. Furthermore, any suitable remote device 106 may be used and may include, without limitation, a mobile device such as a smartphone or tablet, a PC, an artificial-reality system, or the like. The remote device 106 may be a client device to interact with, and/or present content provided by the cloud application platform 102 via a web browser or other application on the remote device 106. Furthermore, the remote device 106 may be in communication with an input device 108 to provide input to the remote device 106. The remote device 106 may, in turn, transmit signals to the cloud application platform 102 to control the application, based in part, on input received from the input device 108. The input device 108 may be any suitable device for providing input and may include, without limitation, a device embodied separately from the remote device 106, such as an external mouse, a keyboard, a game controller, or the like, or a device integrated and/or included with the remote device 106 such as an integrated mouse, a touchscreen, an onboard microphone, or the like.

The cloud application platform 102 may provide an environment with which to execute an application for delivery across the Internet. Specifically, in certain examples, the cloud application platform 102 may provide a server-side hosted environment in which to execute the application. In certain examples, the term “server-side” may refer to a classification of resources that run on a server or other suitable platform to generate and/or deliver content over a network to a remote device 106. As described in more detail below, the cloud application platform 102 may provide various optimizations to allow for enhanced execution of an application such as, for example, applications not designed to operate on the server-side hosted environment, in a cloud-hosted infrastructure, and the like.

In some examples, the cloud application platform 102 may optimize graphics processing of an application executing in the server-side hosted environment, such that an application that is non-native to the server-side hosted environment may execute in such an environment without performance degradation.

In certain examples, and as described in more detail below, the application may be a video game. Furthermore, the video game may be an existing video game designed to execute natively on a local device, on a particular operating system, in a particular environment, or the like. Therefore, the system 100 may host and provide cloud-delivery for an existing game, designed for a different platform, to allow for an end-user to play on the end-user's device without performance degradation and without the need for substantial modifications to the game.

The cloud application platform 102 may have any suitable architecture to allow execution of an application in a server-side hosted environment. FIG. 2 depicts one example of the system 200 with the cloud application platform 102 of FIG. 1 having exemplary architectural details. The cloud application platform 102 may include an operating system 202 in communication with and running on one or more central processing units (“CPUs”) 204a-204n. The operating system 202 may also be in communication with one or more graphics processing units (“GPUs”) 206a-206n for image and graphics processing. The cloud application platform 102 may have any suitable number of CPUs 204 and GPUs 206.

The operating system 202 may be any suitable operating system. In one example, the operating system 202 supports the basic functioning of the cloud application platform 102 such as hardware and software management, access to resources, task management, and the like. The operating system may include an operating system (“OS”) virtualization layer 208 to provide operating system virtualization capabilities allowing the cloud application platform 102 to support multiple, isolated virtual environments. Any suitable OS virtualization layer 208 may be used. In some examples, the OS virtualization layer 208 is a Kernel-based Virtual Machine (“KVM”).

The operating system 202 and OS virtualization layer 208 may support one or more virtual containers 210. The cloud application platform 102 may use any suitable virtual container 210. A virtual container 210, in certain examples, is a virtualized software unit providing an isolated environment for software execution and is described in greater detail below.

A virtual container 210 may provide a sandboxed environment to support and execute a server-side hosted environment 212. Likewise, the server-side hosted environment 212 may, in turn, execute an application 214. As will be described in greater detail below, the server-side hosted environment 212 may be any suitable environment for executing the application 214. In certain examples, the server-side hosted environment 212 may be an operating system, an emulator that emulates a specific operating system, an operating system virtual machine, and the like.

Although FIG. 2 depicts a single application 214 executing on a single server-side hosted environment 212, in other examples, multiple applications 214 may execute on a single server-side hosted environment 212. The server-side hosted environment 212, virtual container 210, virtualization layer 208, and/or the operating system 202 may be configured to provide security and isolation among different applications 214 such that one application 214a is isolated from another 214n. Furthermore, as described in greater detail below, in certain examples, the cloud application platform 102 may dynamically create, allocate, and/or provision instances of a virtual container 210 and/or server-side hosted environment 212 as needed. Specifically, when a user initializes an application 214, the cloud application platform 102 may allocate an instance of a virtual container 210 and/or server-side hosted environment 212 to run the application 214 and then unallocate and/or terminate the instance once the user finishes interacting with the application 214.

The discussion corresponding to FIGS. 1 and 2 is an introduction to the system and further details will be provided in conjunction with the description of the diagrams in FIGS. 3-5.

FIG. 3 is a flow diagram of an exemplary computer-implemented method 300 for optimizing an application 214 in a server-side hosted environment 212. The steps shown in FIG. 3 may be performed by any suitable computer-executable code and/or computing system, including the systems illustrated in FIGS. 1-2. In one example, each of the steps shown in FIG. 3 may represent an algorithm whose structure includes and/or is represented by multiple sub-steps, examples of which will be provided in greater detail below.

As illustrated in FIG. 3, at step 310, one or more of the systems described herein may receive graphics data from an application 214. For example, the cloud application platform 102 may receive, from an application 214 executing in a server-side hosted environment 212, graphics data to be rendered for display on a remote device 106 through which a user interacts with the application 214. The method may use any suitable application 214. In some examples, the term “application” may refer to a software application and/or program that is executed by a processor. The application 214 may be an application of any suitable type or format, including, without limitation, applications directed to consumers or to businesses. In some examples, the application 214 is a video game.

Furthermore, in certain examples, the application 214 is non-native to the server-side hosted environment 212. In some examples, an application 214 being non-native to the server-side hosted environment 212 means that the application 214 is designed to run in a different environment than that provided by the cloud application platform 102 (in a virtual container 210 on a server as part of a cloud-hosted infrastructure, for example). An application 214 that is non-native to the server-side hosted environment 212 may be designed to run on an end-user device, such as a mobile device or PC.

The graphics data, in some embodiments, is data generated by the application 214 that is to be processed to generate graphics, images, and/or video for display to the user. The graphics data may include, but is not limited to, visual user-interface elements, video, images, video game graphics, or the like. The graphics data may include data that is ultimately rendered, encoded, and otherwise processed for display.

The server-side hosted environment 212, in certain examples, is an execution environment for executing one or more instances of an application 214. The server-side hosted environment 212 may be any suitable execution environment. Non-limiting examples may include an operating system, a virtual machine, an operating system emulator, or the like. In certain examples, the server-side hosted environment 212 emulates a native environment suited to operate the application 214. Specifically, the server-side hosted environment 212 may be, without limitation, a mobile device OS emulator such as an ANDROID™ OS emulator, or an OS virtual machine such as a MICROSOFT® WINDOWS® virtual machine. In certain examples, if the application 214 is a video game designed to run natively on a user's ANDROID™ mobile phone, the server-side hosted environment 212 that executes the application 214 on the cloud application platform 102 may be an ANDROID™ OS emulator.

In some examples, the server-side hosted environment 212 runs inside a virtual container 210, which provides a sandboxed execution environment. Any suitable virtual container 210 may be used. The virtual container 210 may provide resource allocation, isolation, security, and the like for the server-side hosted environment 212. In some examples, the method may therefore also include providing a virtual container 210, which may be a sandboxed execution environment, to host the server-side hosted environment 212. In some examples, the cloud application platform 102 may provide the virtual container 210 via the OS virtualization layer 208 (the OS virtualization layer 208 may support one or more virtual containers 210).

In certain examples, the cloud application platform 102 may dynamically provision instances of resources necessary to execute the application 214. Specifically, in certain embodiments, the cloud application platform 102 may dynamically provision instances of the application 214, the server-side hosted environment 212 and/or the virtual container 210. In some examples, to dynamically provision an instance means to dynamically allocate the resources for the particular instance of the application 214, server-side hosted environment 212 and/or virtual container 210 on demand, when sufficient resources are available. For example, the cloud application platform 102 may dynamically provision an instance of a server-side hosted environment 212 with a corresponding application 214 in response to a user requesting access to the application 214 via a remote device 106. In some examples, an application provisioning request may be a request to create the necessary resources (such as an instance of a virtual container 210, server-side hosted environment 212, and/or application 214) to start an application 214 such that a user may interact with the application 214 via a remote device 106. In some examples, the remote device 106 may issue an application provisioning request, or any suitable component of the cloud application platform 102 may issue an application provisioning request in response to a signal from the remote device 106 to interact with the application 214. Therefore, in some examples, the method may include receiving an application provisioning request and dynamically provisioning one or more of the application 214 or the server-side hosted environment 212 within the virtual container 210 in response to receiving the application provisioning request.

Likewise, the cloud application platform 102 may also terminate instances of the application 214, server-side hosted environment 212 and/or virtual container 210 when not in use, for example, when a user has closed the connection, on the remote device 106, to the application 214. In some examples, an application termination request is a signal to terminate instances of dynamically provisioned components providing the application 214 for interaction with the remote device 106. In certain examples, the cloud application platform 102 and/or remote device 106 may issue an application termination request to free up resources when the user ceases to interact with the application 214 via the remote device. In some examples, the cloud application platform 102 may generate an application termination request and convey it to the OS virtualization layer 208, virtual container 201, server-side hosted environment 212 and/or application 214 to terminate instances of some or all of those components to free up the resources that are no longer needed at that time. In these examples, the method 300 may include receiving an application termination request and terminating one or more of the application or the server-side hosted environment 212 within the virtual container 210 in response to receiving the application termination request. Terminating the server-side hosted environment 212, in one example, may include saving a state of the application 214 including any data to persist into the next active session, and freeing the resources for that instance of the server-side hosted environment 212 and/or application 214.

The cloud application platform 102, in some examples, may provision multiple instances of server-side hosted environments 212 and/or virtual containers. Specifically, the cloud application platform 102, in certain examples, may have the capacity to execute multiple applications 214 in multiple server-side hosted environments 212 for multiple users on remote devices 106. The cloud application platform 102 may isolate each application instance such that data in one application 214, server-side hosted environment 212, and/or virtual container, does not leak into other instances of those structures.

The method 300, in these examples, may include receiving an additional application provisioning request, dynamically provisioning one or more of an additional application 214 or an additional server-side hosted environment 212 within an additional virtual container 210 in response to receiving the additional application provisioning request, and executing the additional application 214 in the additional server-side hosted environment 212. In certain examples, the application 214 and additional application 214 may execute concurrently.

Regarding the remote device 106—any suitable remote device 106 may be used with the method 300. Examples of the remote device 106 may include, without limitation, a PC, a mobile device, a server, or the like. In some examples, the remote device 106 is an artificial-reality system having a display for displaying the encoded graphics on the artificial-reality system.

A user may interact with an application 214 through the remote device 106 by inputting commands into the remote device 106 (such as, for example, using an input device 108) which may be transmitted to the application 214 via a network 104 such as the Internet. The application 214 may be responsive to these commands and may provide encoded graphics for display by the remote device 106 as the user interacts with the application 214.

The remote device 106 may display the encoded graphics in any suitable manner. In certain examples, the remote device 106 executes a local application 214 that transmits commands to the cloud application platform 102 and receives encoded graphics, audio, and the like. In some examples, the remote device 106 displays the encoded graphics via a social media application 214 executing on the remote device 106. In certain embodiments in which the application 214 is a video game, the social media application 214 may provide game play to an end user of the remote device 106. For example, the social media application 214 may be designed to interface with the cloud application platform 102 and provide remote application interaction for the user.

In some examples, the remote device 106 displays the encoded graphics via an Internet browser executing on the remote device 106. The browser may transmit commands to the cloud application platform 102 and receive encoded graphics, audio, and the like through Internet protocols such as HyperText Transfer Protocol (“HTTP”). In embodiments in which the application 214 is a video game, the Internet browser may provide game play to an end user of the remote device 106.

As illustrated in FIG. 3, at step 320, one or more of the systems described herein may provide access to the application 214 to the GPU. For example, the cloud application platform 102 may provide access, to the application 214, to a GPU 206 in communication with the server-side hosted environment 212 via an OS virtualization layer 208. As depicted in FIG. 2, the cloud application platform 102 may include one or more GPUs 206 for use by the operating system that provides the one or more virtual containers 210. An application 214, designed to be run on a local device with direct access to a GPU, when running in an isolated sandboxed environment in a server-side hosted environment 212 in a virtual container, may not typically be configured to locate the GPU 206 used by the operating system 202 of the cloud application platform 102. Therefore, in some examples, the cloud application platform 102 provides access to the GPU 206 for the application 214, allowing the GPU 206 to process graphics data from the application 214 via the OS virtualization layer 208. The cloud application platform 102 may provide GPU access through any suitable manner. In some examples, the OS virtualization layer 208 may actively reroute calls to use the GPU from the application 214 to the GPU 206 of the cloud application platform 102 (rather than a local GPU in the applications 214 native executing environment). The OS virtualization layer 208 may provide a dedicated GPU 206 for a particular virtual container 210 and/or server-side hosted environment 212, or may share a GPU 206 among multiple virtual containers 210 and/or server-side hosted environment 212

As illustrated in FIG. 3 at step 330, one or more of the systems described herein may render the graphics data. For example, the cloud application platform 102 may render the graphics data with the GPU 206. Referring also to FIG. 4, which depicts an exemplary graphics pipeline 400, the GPU 206 may receive graphics data 402 from a particular application 214 running in a server-side hosted environment 212, and may render 406 the graphics data.

As illustrated in FIG. 3 at step 340, one or more of the systems described herein may store 408 the rendered graphics 410. For example, the cloud application platform 102 may store the rendered graphics 410 in shared memory 404 of the GPU 206. In certain examples, by storing the rendered graphics 410 in the shared memory 404, the rendered graphics 410 may be available to the GPU 206 in a different stage of graphics processing without copying the rendered graphics 410 off of the GPU 206 and then retrieving the rendered graphics 410 from memory external to the GPU 206.

Specifically, as illustrated in FIG. 3 at step 350, one or more of the systems described herein may access and encode the rendered graphics. For example, the cloud application platform 102 may access 412 the rendered graphics from shared memory 404 and encode 414 the rendered graphics 410 with the GPU 206 in a manner that reduces latency in displaying the encoded graphics on the remote device 106. As mentioned above, the GPU may access the rendered graphics from shared memory for a different stage of graphics processing—the encoding stage—without having to retrieve the rendered graphics 410 from external memory. The GPU 206 may encode the rendered graphics 410 for delivery to the remote device 106. By performing both the rendering and encoding stages of graphics processing on the GPU 206 using shared memory, the cloud application platform 102 may decrease latency in graphics processing by avoiding excess copies to memory. By making server-side processing more efficient, the cloud application platform 102 reduces latency in displaying graphics on the remote device 106. As a result of these server-side optimizations, the frame rate and graphics quality of graphics delivered to the remote device 106 may be optimized for the user even though the application 214 is not designed to natively run as a cloud-hosted application 214.

Once the graphics are rendered and encoded, as illustrated in FIG. 3 at step 360, one or more of the systems described herein may provide the encoded graphics 416 to the remote device 106. For example, the cloud application platform 102 may provide the encoded graphics to the remote device 106 over a network connection with the remote device 106. The cloud application platform 102 may provide the encoded graphics in any suitable manner. In certain examples, the cloud application platform 102 may transmit the encoded graphics over the network 104, such as the Internet, using Internet protocols as described above. The remote device 106 may display the encoded graphics in any suitable manner. For example, the remote device 106 may display the graphics through a browser, locally executing application such as a social media application as described above, or the like.

As described above, in some embodiments, the cloud application platform 102 may execute multiple instances of virtual containers 210, server-side hosted environments 212, and/or applications 214 concurrently. Therefore, in some examples, the method 300 may include steps to process additional graphics data for other instances of server-side hosted environments 212, applications 214, and remote devices 106 substantially in parallel with the server-side hosted environment 212 described above. Specifically, the method 300 may include the step of receiving, from an additional application 214, additional graphics data to be rendered for display on an additional remote device 106. The method 300 may include providing access, to the additional application 214, to the GPU 206, rendering the additional graphics data with the GPU 206, storing the rendered additional graphics in the shared memory of the GPU 206, and accessing the rendered additional graphics from shared memory and encoding the rendered additional graphics with the GPU 206. Furthermore, the method 300 may include the step of providing the encoded additional graphics to the additional remote device 106. The application 214 and additional application 214 may use the same GPU, in certain examples, or may use different GPUs 206 made available by the OS virtualization layer.

As described above, the cloud application platform 102 may reduce latency for an application 214 running in the server-side hosted environment 212. The present disclosure may also include a method 500 for measuring latency in the application 214. Specifically, FIG. 5 is a flow diagram of an exemplary computer-implemented method 500 for measuring latency of an application 214 in a server-side hosted environment 212. The steps shown in FIG. 5 may be performed by any suitable computer-executable code and/or computing system, including the systems illustrated in FIGS. 1-2. In one example, each of the steps shown in FIG. 5 may represent an algorithm whose structure includes and/or is represented by multiple sub-steps, examples of which will be provided in greater detail below.

As illustrated in FIG. 5, at step 510, one or more of the systems described herein may determine when an input is entered on a remote device 106. For example, the cloud application platform 102 may determine a first time when an input is entered on the remote device 106. In certain embodiments, the cloud application platform 102 may determine the first time by estimating a time in which the user entered an input. For example, the cloud application platform 102 may, using a pre-determined measure of the typical length of time it takes for an input to reach the cloud application platform 102, determine when the input was entered.

As illustrated in FIG. 5, at step 520, one or more of the systems described herein may determine a second time. For example, the cloud application platform 102 may determine a second time when a video frame of the encoded graphics arrives on the remote device 106. In some examples, the cloud application platform 102 may determine a correlation between the video frame and the input. For example, the video frame may be provided to the remote device 106 in response to the input. The cloud application platform 102 may determine a correlation between an input and a video frame in any suitable manner. In some examples, the cloud application platform 102 may determine that a particular video frame is displayed in response to a particular input from the user. The cloud application platform 102 may estimate the second time (the time in which the video frame arrives on the remote device 106) using a predetermined length of time that a video frame typically takes to arrive at a remote device 106.

As illustrated in FIG. 5, at step 530, one or more of the systems described herein may compare the first time with the second time. For example, the cloud application platform 102 may compare the first time with the second time to measure a latency of providing the encoded graphics to the remote device 106, it being a measure of how long between when an input was entered and when a video frame was delivered to the remote device 106.

The subject matter disclosed herein may be implemented in a variety of ways, with a variety of remote devices 106. However, certain examples may include an artificial-reality system. For example, as described above, a remote device 106, through which a user interacts with the application 214, may be an artificial-reality system. Therefore, the present disclosure will provide a detailed discussion of exemplary artificial-reality systems.

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 600 in FIG. 6) or that visually immerses a user in an artificial reality (such as, e.g., virtual-reality system 700 in FIG. 7). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 6, augmented-reality system 600 may include an eyewear device 602 with a frame 610 configured to hold a left display device 615(A) and a right display device 615(B) in front of a user's eyes. Display devices 615(A) and 615(B) may act together or independently to present an image or series of images to a user. While augmented-reality system 600 includes two displays, embodiments of this disclosure may be implemented in augmented-reality systems with a single NED or more than two NEDs.

In some embodiments, augmented-reality system 600 may include one or more sensors, such as sensor 640. Sensor 640 may generate measurement signals in response to motion of augmented-reality system 600 and may be located on substantially any portion of frame 610. Sensor 640 may represent one or more of a variety of different sensing mechanisms, such as a position sensor, an inertial measurement unit (IMU), a depth camera assembly, a structured light emitter and/or detector, or any combination thereof. In some embodiments, augmented-reality system 600 may or may not include sensor 640 or may include more than one sensor. In embodiments in which sensor 640 includes an IMU, the IMU may generate calibration data based on measurement signals from sensor 640. Examples of sensor 640 may include, without limitation, accelerometers, gyroscopes, magnetometers, other suitable types of sensors that detect motion, sensors used for error correction of the IMU, or some combination thereof.

In some examples, augmented-reality system 600 may also include a microphone array with a plurality of acoustic transducers 620(A)-620(J), referred to collectively as acoustic transducers 620. Acoustic transducers 620 may represent transducers that detect air pressure variations induced by sound waves. Each acoustic transducer 620 may be configured to detect sound and convert the detected sound into an electronic format (e.g., an analog or digital format). The microphone array in FIG. 6 may include, for example, ten acoustic transducers: 620(A) and 620(B), which may be designed to be placed inside a corresponding ear of the user, acoustic transducers 620(C), 620(D), 620(E), 620(F), 620(G), and 620(H), which may be positioned at various locations on frame 610, and/or acoustic transducers 620(I) and 620(J), which may be positioned on a corresponding neckband 605.

In some embodiments, one or more of acoustic transducers 620(A)-(J) may be used as output transducers (e.g., speakers). For example, acoustic transducers 620(A) and/or 620(B) may be earbuds or any other suitable type of headphone or speaker.

The configuration of acoustic transducers 620 of the microphone array may vary. While augmented-reality system 600 is shown in FIG. 6 as having ten acoustic transducers 620, the number of acoustic transducers 620 may be greater or less than ten. In some embodiments, using higher numbers of acoustic transducers 620 may increase the amount of audio information collected and/or the sensitivity and accuracy of the audio information. In contrast, using a lower number of acoustic transducers 620 may decrease the computing power required by an associated controller 650 to process the collected audio information. In addition, the position of each acoustic transducer 620 of the microphone array may vary. For example, the position of an acoustic transducer 620 may include a defined position on the user, a defined coordinate on frame 610, an orientation associated with each acoustic transducer 620, or some combination thereof.

Acoustic transducers 620(A) and 620(B) may be positioned on different parts of the user's ear, such as behind the pinna, behind the tragus, and/or within the auricle or fossa. Or, there may be additional acoustic transducers 620 on or surrounding the ear in addition to acoustic transducers 620 inside the ear canal. Having an acoustic transducer 620 positioned next to an ear canal of a user may enable the microphone array to collect information on how sounds arrive at the ear canal. By positioning at least two of acoustic transducers 620 on either side of a user's head (e.g., as binaural microphones), augmented-reality device 600 may simulate binaural hearing and capture a 3D stereo sound field around about a user's head. In some embodiments, acoustic transducers 620(A) and 620(B) may be connected to augmented-reality system 600 via a wired connection 630, and in other embodiments acoustic transducers 620(A) and 620(B) may be connected to augmented-reality system 600 via a wireless connection (e.g., a BLUETOOTH connection). In still other embodiments, acoustic transducers 620(A) and 620(B) may not be used at all in conjunction with augmented-reality system 600.

Acoustic transducers 620 on frame 610 may be positioned in a variety of different ways, including along the length of the temples, across the bridge, above or below display devices 615(A) and 615(B), or some combination thereof. Acoustic transducers 620 may also be oriented such that the microphone array is able to detect sounds in a wide range of directions surrounding the user wearing the augmented-reality system 600. In some embodiments, an optimization process may be performed during manufacturing of augmented-reality system 600 to determine relative positioning of each acoustic transducer 620 in the microphone array.

In some examples, augmented-reality system 600 may include or be connected to an external device (e.g., a paired device), such as neckband 605. Neckband 605 generally represents any type or form of paired device. Thus, the following discussion of neckband 605 may also apply to various other paired devices, such as charging cases, smart watches, smart phones, wrist bands, other wearable devices, hand-held controllers, tablet computers, laptop computers, other external compute devices, etc.

As shown, neckband 605 may be coupled to eyewear device 602 via one or more connectors. The connectors may be wired or wireless and may include electrical and/or non-electrical (e.g., structural) components. In some cases, eyewear device 602 and neckband 605 may operate independently without any wired or wireless connection between them. While FIG. 6 illustrates the components of eyewear device 602 and neckband 605 in example locations on eyewear device 602 and neckband 605, the components may be located elsewhere and/or distributed differently on eyewear device 602 and/or neckband 605. In some embodiments, the components of eyewear device 602 and neckband 605 may be located on one or more additional peripheral devices paired with eyewear device 602, neckband 605, or some combination thereof.

Pairing external devices, such as neckband 605, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 600 may be provided by a paired device or shared between a paired device and an eyewear device, thus reducing the weight, heat profile, and form factor of the eyewear device overall while still retaining desired functionality. For example, neckband 605 may allow components that would otherwise be included on an eyewear device to be included in neckband 605 since users may tolerate a heavier weight load on their shoulders than they would tolerate on their heads. Neckband 605 may also have a larger surface area over which to diffuse and disperse heat to the ambient environment. Thus, neckband 605 may allow for greater battery and computation capacity than might otherwise have been possible on a stand-alone eyewear device. Since weight carried in neckband 605 may be less invasive to a user than weight carried in eyewear device 602, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 605 may be communicatively coupled with eyewear device 602 and/or to other devices. These other devices may provide certain functions (e.g., tracking, localizing, depth mapping, processing, storage, etc.) to augmented-reality system 600. In the embodiment of FIG. 6, neckband 605 may include two acoustic transducers (e.g., 620(I) and 620(J)) that are part of the microphone array (or potentially form their own microphone subarray). Neckband 605 may also include a controller 625 and a power source 635.

Acoustic transducers 620(I) and 620(J) of neckband 605 may be configured to detect sound and convert the detected sound into an electronic format (analog or digital). In the embodiment of FIG. 6, acoustic transducers 620(I) and 620(J) may be positioned on neckband 605, thereby increasing the distance between the neckband acoustic transducers 620(I) and 620(J) and other acoustic transducers 620 positioned on eyewear device 602. In some cases, increasing the distance between acoustic transducers 620 of the microphone array may improve the accuracy of beamforming performed via the microphone array. For example, if a sound is detected by acoustic transducers 620(C) and 620(D) and the distance between acoustic transducers 620(C) and 620(D) is greater than, e.g., the distance between acoustic transducers 620(D) and 620(E), the determined source location of the detected sound may be more accurate than if the sound had been detected by acoustic transducers 620(D) and 620(E).

Controller 625 of neckband 605 may process information generated by the sensors on neckband 605 and/or augmented-reality system 600. For example, controller 625 may process information from the microphone array that describes sounds detected by the microphone array. For each detected sound, controller 625 may perform a direction-of-arrival (DOA) estimation to estimate a direction from which the detected sound arrived at the microphone array. As the microphone array detects sounds, controller 625 may populate an audio data set with the information. In embodiments in which augmented-reality system 600 includes an inertial measurement unit, controller 625 may compute all inertial and spatial calculations from the IMU located on eyewear device 602. A connector may convey information between augmented-reality system 600 and neckband 605 and between augmented-reality system 600 and controller 625. The information may be in the form of optical data, electrical data, wireless data, or any other transmittable data form. Moving the processing of information generated by augmented-reality system 600 to neckband 605 may reduce weight and heat in eyewear device 602, making it more comfortable to the user.

Power source 635 in neckband 605 may provide power to eyewear device 602 and/or to neckband 605. Power source 635 may include, without limitation, lithium ion batteries, lithium-polymer batteries, primary lithium batteries, alkaline batteries, or any other form of power storage. In some cases, power source 635 may be a wired power source. Including power source 635 on neckband 605 instead of on eyewear device 602 may help better distribute the weight and heat generated by power source 635.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 700 in FIG. 7, that mostly or completely covers a user's field of view. Virtual-reality system 700 may include a front rigid body 702 and a band 704 shaped to fit around a user's head. Virtual-reality system 700 may also include output audio transducers 706(A) and 706(B). Furthermore, while not shown in FIG. 7, front rigid body 702 may include one or more electronic elements, including one or more electronic displays, one or more inertial measurement units (IMUS), one or more tracking emitters or detectors, and/or any other suitable device or system for creating an artificial-reality experience.

Artificial-reality systems may include a variety of types of visual feedback mechanisms. For example, display devices in augmented-reality system 600 and/or virtual-reality system 700 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., conventional concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 600 and/or virtual-reality system 700 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 600 and/or virtual-reality system 700 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

In conclusion, an application 214 that may be designed for native execution locally on a user device such as a mobile device or PC, may be executed in a server-side hosted environment 212 and delivered as a cloud-hosted service. To reduce latency in executing the application 214 in this manner, the cloud application platform 102 may optimize graphics processing by performing both rendering and encoding with the GPU of the cloud application platform 102. As a result, a user may play a game or run another type of application 214 over the cloud while minimizing any modifications to the game or application 214.

### EXAMPLE EMBODIMENTS

### Example 1

A computer-implemented method may include (i) receiving, from an application executing in a server-side hosted environment, graphics data to be rendered for display on a remote device through which a user interacts with the application, (ii) providing access, to the application, to a graphics processing unit (“GPU”) in communication with the server-side hosted environment via an operating system (“OS”) virtualization layer, (iii) rendering the graphics data with the GPU, (iv) storing the rendered graphics in shared memory of the GPU, (v) accessing the rendered graphics from shared memory and encoding the rendered graphics with the GPU in a manner that reduces latency in displaying the encoded graphics on the remote device, (vi) providing the encoded graphics to the remote device over a network connection with the remote device.

### Example 2

The computer-implemented method of Example 1, where the application is a video game.

### Example 3

The computer-implemented method of any of Examples 1 and 2 where the remote device displays the encoded graphics via one of (1) a social media application executing on the remote device, the social media application providing game play to an end user of the remote device, or (2) an Internet browser executing on the remote device, the Internet browser providing game play to an end user of the remote device.

### Example 4

The computer-implemented method of any of Examples 1-3, where the remote device includes an artificial-reality system having a display for displaying the encoded graphics on the artificial-reality system.

### Example 5

The computer-implemented method of any of Examples 1-4, where the application is non-native to the server-side hosted environment and where the server-side hosted environment emulates a native environment suited to operate the application.

### Example 6

The computer-implemented method of any of Examples 1-5, where the server-side hosted environment includes one of (1) a mobile device OS emulator, or (2) an OS virtual machine.

### Example 7

The computer-implemented method of any of Examples 1-6, where the mobile device OS emulator includes an ANDROID™ OS emulator.

### Example 8

The computer-implemented method of any of Examples 1-7, where the OS virtual machine includes a MICROSOFT® WINDOWS® virtual machine.

### Example 9

The computer-implemented method of any of Examples 1-8, where the method further includes (i) providing a virtual container via the OS virtualization layer, the virtual container including a sandboxed execution environment, and (ii) running the server-side hosted environment within the virtual container.

### Example 10

The computer-implemented method of any of Examples 1-9, further including (i) receiving an application provisioning request, and (ii) dynamically provisioning one or more of the application or the server-side hosted environment within the virtual container in response to receiving the application provisioning request.

### Example 11

The computer-implemented method of any of Examples 1-10, further including (i) receiving an additional application provisioning request, (ii) dynamically provisioning one or more of an additional application or an additional server-side hosted environment within an additional virtual container in response to receiving the additional application provisioning request, (iii) executing the additional application in the additional server-side hosted environment, wherein the application and additional application execute concurrently.

### Example 12

The computer-implemented method of any of Examples 1-11, further including (i) receiving, from the additional application, additional graphics data to be rendered for display on an additional remote device, (ii) providing access, to the additional application, to the GPU (iii) rendering the additional graphics data with the GPU, (iv) storing the rendered additional graphics in the shared memory of the GPU, (v) accessing the rendered additional graphics from shared memory and encoding the rendered additional graphics with the GPU, and (vi) providing the encoded additional graphics to the additional device.

### Example 13

The computer-implemented method of Examples 1-12, further including (i) receiving an application termination request, (ii) terminating one or more of the application or the server-side hosted environment within a virtual container in response to receiving the application termination request.

### Example 14

The computer-implemented method of Examples 1, further including (i) determining a first time when an input is entered on the remote device, (ii) determining a second time when a video frame of the encoded graphics arrives on the remote device, the video frame provided to the remote device in response to the input, and (iii) comparing the first time with the second time to measure a latency of providing the encoded graphics to the remote device.

### Example 15

A method may include (i) receiving, from an application executing in a server-side hosted environment, graphics data to be rendered for display on a remote device through which a user interacts with the application, (ii) access, to the application, to a graphics processing unit (“GPU”) in communication with the server-side hosted environment via an operating system (“OS”) virtualization layer, (iii) rendering the graphics data with the GPU, (iv) storing the rendered graphics in shared memory of the GPU, (v) accessing the rendered graphics from shared memory and encoding the rendered graphics with the GPU in a manner that reduces latency in displaying the encoded graphics on the remote device, and (vi) providing the encoded graphics to the remote device over a network connection with the remote device.

### Example 16

The method of Examples 15, where the application includes a video game.

### Example 17

The method of any of Examples 15-16, where the remote device displays the encoded graphics via one of (1) a social media application executing on the remote device, the social media application providing game play to an end user of the remote device, or (2) an Internet browser executing on the remote device, the Internet browser providing game play to an end user of the remote device.

### Example 18

The method of any of Examples 15-17, where the application is non-native to the server-side hosted environment and wherein the server-side hosted environment emulates a native environment suited to operate the application.

### Example 19

A system includes (i) a graphics processing unit (“GPU”) in communication with a server-side hosted environment via an operating system (“OS”) virtualization layer, the GPU configured to (1) render graphics data received from an application executing in the server-side hosted environment, the graphics data for display on a remote device through which a user interacts with the application, (2) store the rendered graphics in shared memory of the GPU, (3) access the rendered graphics from shared memory and encode the rendered graphics in a manner that reduces latency in displaying the encoded graphics on the remote device, (ii) at least one physical processor, and (iii) physical memory including computer-executable instructions that, when executed by the physical processor, cause the physical processor to (1) receive, from the application, the graphics data to be rendered for display on the remote device, (2) provide access, to the application, to the GPU, and (3) provide the encoded graphics to the remote device over a network connection with the remote device.

### Example 20

The system of Examples 19, where the application includes a video game and where the remote device displays the encoded graphics via one of a (1) social media application executing on the remote device, the social media application providing game play to an end user of the remote device, or (2) an Internet browser executing on the remote device, the Internet browser providing game play to an end user of the remote device.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules and/or systems described herein may transform data, physical devices, and/or representations of physical devices from one form to another. For example, the cloud application platform 102 recited herein may receive graphics data to be transformed, transform the graphics data by rendering and encoding the graphics data, store the result of the transformation to prepare the encoded graphics for transmission to a remote device, output a result of the transformation to provide the encoded graphics to a remote device 106, and use the result of the transformation to allow interaction with the application over a network. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
receiving, from an application executing in a server-side hosted environment, graphics data to be rendered for display on a remote device through which a user interacts with the application;
providing access, to the application, to a graphics processing unit (“GPU”) in communication with the server-side hosted environment via an operating system (“OS”) virtualization layer;
rendering the graphics data with the GPU;
storing the rendered graphics in shared memory of the GPU;
accessing the rendered graphics from shared memory and encoding the rendered graphics with the GPU in a manner that reduces latency in displaying the encoded graphics on the remote device; and
providing the encoded graphics to the remote device over a network connection with the remote device.

2. The computer-implemented method of claim 1, wherein the application comprises a video game.

3. The computer-implemented method of claim 2, wherein the remote device displays the encoded graphics via one of:
a social media application executing on the remote device, the social media application providing game play to an end user of the remote device; or
an Internet browser executing on the remote device, the Internet browser providing game play to an end user of the remote device.

4. The computer-implemented method of claim 1, wherein the remote device comprises an artificial-reality system having a display for displaying the encoded graphics on the artificial-reality system.

5. The computer-implemented method of claim 1, wherein the application is non-native to the server-side hosted environment and wherein the server-side hosted environment emulates a native environment suited to operate the application.

6. The computer-implemented method of claim 1, wherein the server-side hosted environment comprises one of:
a mobile device OS emulator; or
an OS virtual machine.

7. The computer-implemented method of claim 6, wherein the mobile device OS emulator comprises an ANDROID™ OS emulator.

8. The computer-implemented method of claim 6, where the OS virtual machine comprises a MICROSOFT® WINDOWS® virtual machine.

9. The computer-implemented method of claim 1, the method further comprising:
providing a virtual container via the OS virtualization layer, the virtual container comprising a sandboxed execution environment; and
running the server-side hosted environment within the virtual container.

10. The computer-implemented method of claim 9, further comprising:
receiving an application provisioning request; and
dynamically provisioning one or more of the application or the server-side hosted environment within the virtual container in response to receiving the application provisioning request.

11. The computer-implemented method of claim 10, further comprising:
receiving an additional application provisioning request;
dynamically provisioning one or more of an additional application or an additional server-side hosted environment within an additional virtual container in response to receiving the additional application provisioning request; and
executing the additional application in the additional server-side hosted environment, wherein the application and additional application execute concurrently.

12. The computer-implemented method of claim 11, further comprising:
receiving, from the additional application, additional graphics data to be rendered for display on an additional remote device;
providing access, to the additional application, to the GPU;
rendering the additional graphics data with the GPU;
storing the rendered additional graphics in the shared memory of the GPU;
accessing the rendered additional graphics from shared memory and encoding the rendered additional graphics with the GPU; and
providing the encoded additional graphics to the additional device.

13. The computer-implemented method of claim 1, further comprising:
receiving an application termination request; and
terminating one or more of the application or the server-side hosted environment within a virtual container in response to receiving the application termination request.

14. The computer-implemented method of claim 1, further comprising:
determining a first time when an input is entered on the remote device;
determining a second time when a video frame of the encoded graphics arrives on the remote device, the video frame provided to the remote device in response to the input; and
comparing the first time with the second time to measure a latency of providing the encoded graphics to the remote device.

15. A method comprising:
receiving, from an application executing in a server-side hosted environment, graphics data to be rendered for display on a remote device through which a user interacts with the application;
providing access, to the application, to a graphics processing unit (“GPU”) in communication with the server-side hosted environment via an operating system (“OS”) virtualization layer;
rendering the graphics data with the GPU;
storing the rendered graphics in shared memory of the GPU;
accessing the rendered graphics from shared memory and encoding the rendered graphics with the GPU in a manner that reduces latency in displaying the encoded graphics on the remote device; and
providing the encoded graphics to the remote device over a network connection with the remote device.

16. The method of claim 15, wherein the application comprises a video game.

17. The method of claim 16, wherein the remote device displays the encoded graphics via one of:
a social media application executing on the remote device, the social media application providing game play to an end user of the remote device; or
an Internet browser executing on the remote device, the Internet browser providing game play to an end user of the remote device.

18. The method of claim 15, wherein the application is non-native to the server-side hosted environment and wherein the server-side hosted environment emulates a native environment suited to operate the application.

19. A system comprising:
a graphics processing unit (“GPU”) in communication with a server-side hosted environment via an operating system (“OS”) virtualization layer, the GPU configured to:
render graphics data received from an application executing in the server-side hosted environment, the graphics data for display on a remote device through which a user interacts with the application;
store the rendered graphics in shared memory of the GPU;
access the rendered graphics from shared memory and encode the rendered graphics in a manner that reduces latency in displaying the encoded graphics on the remote device;
at least one physical processor; and
physical memory comprising computer-executable instructions that, when executed by the physical processor, cause the physical processor to:
receive, from the application, the graphics data to be rendered for display on the remote device;
provide access, to the application, to the GPU; and
provide the encoded graphics to the remote device over a network connection with the remote device.

20. The system of claim 19, wherein the application comprises a video game and wherein the remote device displays the encoded graphics via one of:
a social media application executing on the remote device, the social media application providing game play to an end user of the remote device; or
an Internet browser executing on the remote device, the Internet browser providing game play to an end user of the remote device.
